(19) United States
(12) Patent Application Publication
(10) Pub. No.: US 2008/0187800 A1
(43) Pub. Date: Aug. 7, 2008

(54) WATER RECYCLING SYSTEM FOR FUEL CELL

(76) Inventors: CHIEN-AN CHEN, Kaohsiung (TW); WEI-JUI CHUANG, Kaohsiung (TW); CHIEN-CHOU CHEN, Kaohsiung (TW)

Correspondence Address: G. LINK CO., LTD., 3550 BELL ROAD, MINOOKA, IL, 60447, US

(21) Appl. No.: 11/537,938

(22) Filed: Oct. 2, 2006

(51) Int. Cl. H01M 8/06

(52) U.S. Cl. 429/20

(57) ABSTRACT

A water recycling system for fuel cell includes a water trough, a first pump, a fuel tank, a mixing tank and a second pump. The water trough receives condensed water from the condenser and connects with a first throttle valve. The first pump is connected to the first throttle valve. The fuel tank is connected to a second throttle valve, and the second throttle valve is connected to the first pump. The mixing tank is connected to the first pump and the second pump respectively. A thickness sensor and a level sensor are arranged in the mixing tank to detect thickness of the fuel and liquid level of the mixing liquid in the mixing tank. The first throttle valve, the first pump, the second throttle valve, the second pump, the thickness sensor and the level sensor are electrically connected the to a micro control unit so as to actuate the first throttle valve, the first pump, the second throttle valve and the second pump under control for regulating and controlling thickness of the fuel in the fuel tank

### BACKGROUND OF THE INVENTION

1. Field of the Invention

The present invention is related to a water recycling system for fuel cell and, particularly, related to a water recycling system, which is capable of detecting thickness of fuel and liquid level for the water and methyl alcohol mixing with a proper proportion while the fuel cell is in operation.

2. Brief Description of the Related Art

Usually, water consumes in the operation of a fuel cell system and it is very important to add water in the system in order to maintain thickness of methyl alcohol in the fuel cell. The prior art has been proposed many design concept. However, generally, methyl alcohol and water are driven by different pumps in a control unit of the fuel cell such that it not only wastes energy but also increase cost because of the pumps being expensive. Further, fuel added amount is different for each time of fuel addition. Hence, the problem related to supplemental methyl alcohol and water is always there. It is complicate to control that how much water has to be added for matching methyl alcohol in order to fill up the fuel tank under a condition of keeping a constant thickness.

Addition and control of methyl alcohol or water have relationships with running time of pumps. Either methyl alcohol or water has to be added to an experience amount first and then the second is supplemented to an extent of the mixing solution reaching a preset thickness. However, it is hard to fill up the fuel tank in consistent with meeting preset thickness of the fuel cell at the same time. In order to solve the preceding problem, a level sensor is applied to detect liquid level so that the control unit of the fuel cell is capable of estimating the gross amount needed to add in the fuel tank and dispatching supplemental amounts of methyl alcohol and water respectively based on information of the detected liquid level. Although the preceding problem has been overcome, it increases the overall cost of the system.

### SUMMARY OF THE INVENTION

Accordingly, an object of the present invention is to provide a water recycling system for fuel cell, which has throttle valves in association with the control unit and detection of fuel thickness to maintain the mixing solution of methyl alcohol and water at a preset consistence and to keep liquid level of the fuel tank.

Another object of the present invention is to provide a water recycling system for fuel cell in which a throttle valve is in a state of opening to admit water entering the fuel tank normally and the control unit allows another throttle valve admitting fuel to enter the fuel tank and/or the first throttle valve being shut for maintaining thickness of the fuel.

A further object of the present invention is to provide a water recycling system for fuel cell with which the moisture generated from running fuel cell is capable of being cooled down as water by a condenser and the condensed water is recycled for further use.

A further object of the present invention is to provide a water recycling system for fuel cell with which reliability of the fuel cell can be enhanced substantially.

In order to achieve the preceding objects, the water recycling system for fuel cell according to the present invention includes a water trough, a first pump, a fuel tank, a mixing tank and a second pump. The water trough receives condensed water from the condenser and connects with a first throttle valve. The first pump is connected to the first throttle valve. The fuel tank is connected to a second throttle valve and the second throttle valve is connected to the first pump. The mixing tank is connected to the first pump and the second pump respectively. Further, a thickness sensor and a level sensor are arranged in the mixing tank to detect thickness of the fuel and liquid level of the mixing liquid in the mixing tank. The first throttle valve, the first pump, the second throttle valve, the second pump, the thickness sensor and the level sensor are electrically connected the to a micro control unit such that actuation of the first throttle valve, the first pump, the second throttle valve and the second pump can be controlled for regulating and controlling thickness of the fuel in the fuel tank.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a block diagram of the first embodiment of a water cycling system for fuel cell according to the present invention; and

FIG. 2 is a block diagram of the second embodiment of a water cycling system for fuel cell according to the present invention.

### DETAILED DESCRIPTION OF THE INVENTION

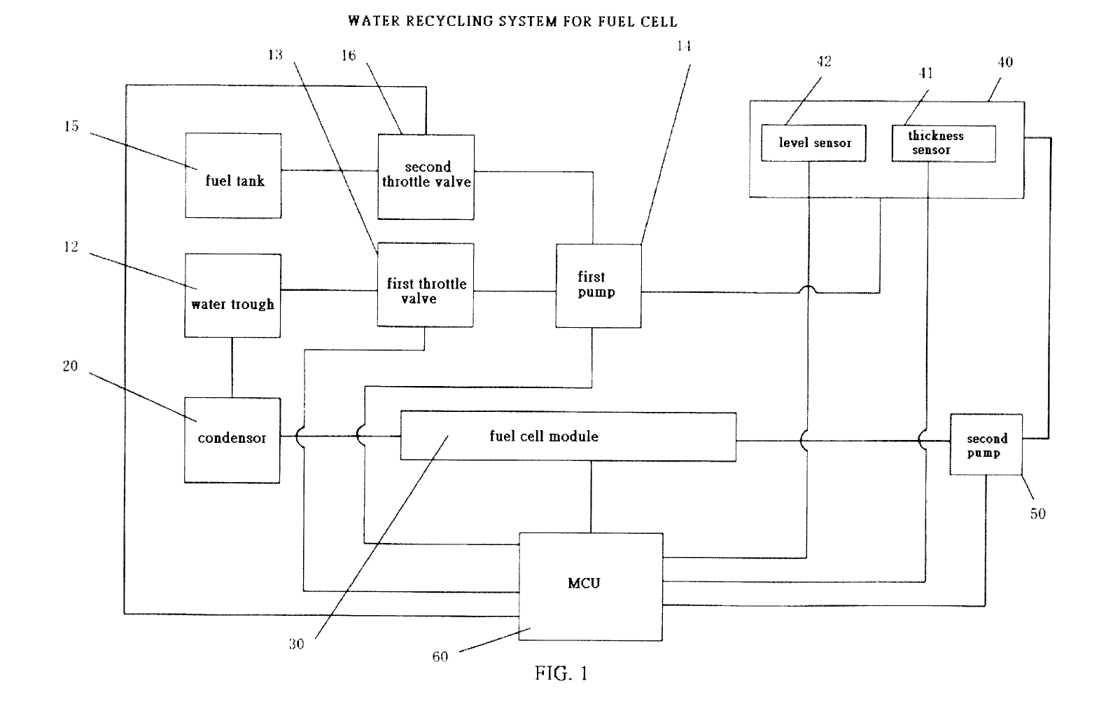

Referring to FIG. 1, the first embodiment of a water cycling system for fuel cell according to the present invention provides a condenser 20, which is connected to a fuel cell module 30, to cool down moisture generated during the fuel cell module 30 being in operation. It is noted that the fuel cell module 30 can be operated in a process the same as manufacturing process for a printed circuit board to result in electrochemical reaction and generate power. The water recycling system of the first embodiment further includes a moisture collecting tank 11, which is capable of collecting the moisture, for the collected moisture being cooled down by the condenser 20 as water, and a water trough 12, which is connected to the moisture collecting tank 11 to receive the condensed water.

The water trough 12 is connected to a throat valve 13 and a first pump 14 is connected to the first throat valve 13 such that moisture through the throat valve 13 can be sucked up by the first pump 14. A fuel tank 15 is connected to a second throat valve 16 and the throat valve 16 further connects with the first pump 14 such that fuel in the fuel tank 15 can be sucked up by the first pump 14.

A mixing tank 40, which is connected to the first pump 14, is received the water from the first pump 14 to mix fuel as mixing liquid. A second pump 50, which is connected to the mixing tank 40, sucks the mixing liquid and deliver the mixing liquid to the fuel cell module 30 for supplying fuel with proper thickness to the fuel cell module 30.

A thickness sensor 41 and a level sensor 42 are disposed in the mixing tank 40 to detect thickness of the mixing liquid and level of the mixing liquid in the mixing tank 40. The first throttle valve 13, the first pump 14, the second throttle valve 16, the second pump 50, the thickness sensor 41 and the level sensor 42 are connected to a micro control unit (MCU) 60 and the micro control unit 60 is capable of receiving and/or controlling detected data or controlling actuation state of the above components. That is, the MCU 60 is capable of controlling actuation of the first throttle valve 13, the first pump 14, the second throttle valve 16 and the second pump 50 by means of receiving or reading thickness of fuel detected by the thickness sensor 41 and receiving and reading liquid level of the mixing liquid detected by the level sensor 42 in a way of, for instance, the MCU 60 transmitting pulse width modulation signal to modulate work cycles of the first throttle valve 13, the first pump 14, the second throttle valve 16 and the second pump 50.

Once the MCU 60 receives data from the level sensor 42 to know the liquid level of the mixing tank 40 is below a preset level such as a highest level or a level preset by the system, the first throttle valve 13 keeps in a state of opening to admit the water from the first throttle valve 13 being sucked by the first pump 14 and entering the mixing tank 40 continuously.

Nevertheless, the thickness of the fuel in the mixing tank 40 is getting thinner in case of more water entering the mixing tank 40. Once the MCU 60 has learned the thickness of the fuel detected by the thickness sensor 411 is lower than a preset value, the MCU 60 opens the second throttle valve 16 to admit the fuel in the fuel tank 15 being sucked into the mixing tank 40 by the first pump 14 to increase the thickness of the fuel in the mixing tank 40 till a predetermined thickness is reached. Then, the second throttle valve 16 is closed by the MCU 60 to avoid excessive thickness such that a constant value of the thickness can be maintained normally.

When the MCU 60 has learned the preset liquid level in the mixing tank 40 is reached, the first throttle valve 13 is closed and/or the first pump 14 is stopped running to save power.

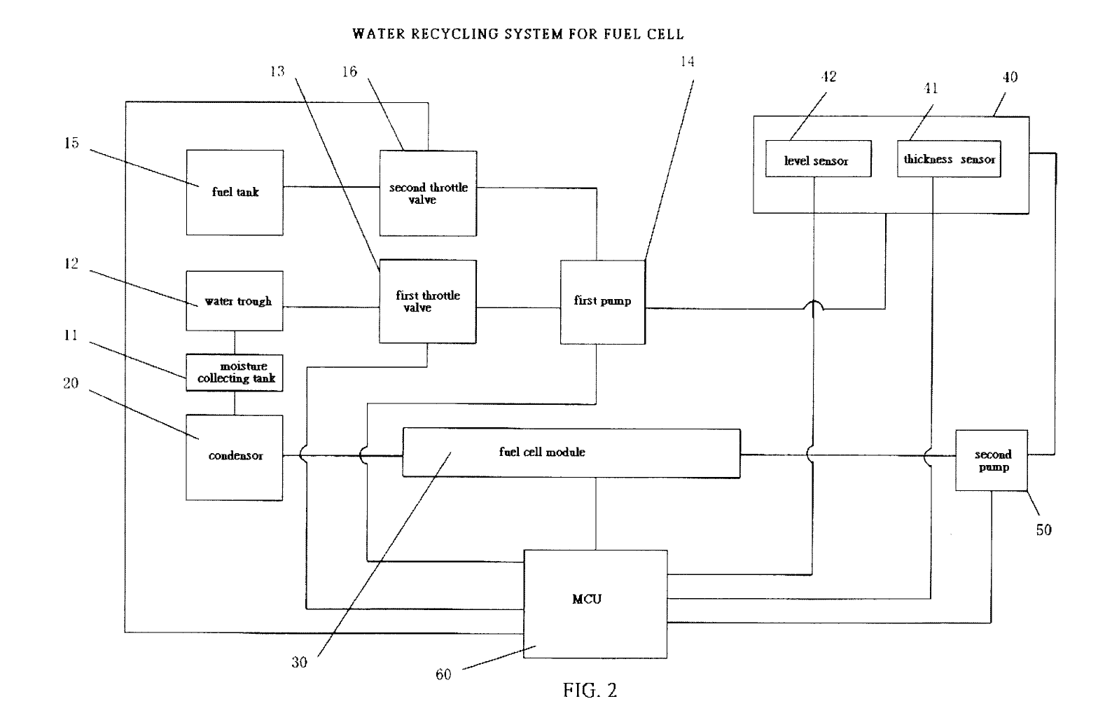

Referring to FIG. 2, the second embodiment of the present invention is illustrated. Arrangement of the second embodiment is almost the same as the first embodiment and the only difference is in that the moisture collecting tank 11 in the first embodiment is not provided in the second embodiment. The function of the moisture collection is performed with the water trough 12.

While the invention has been described with referencing to preferred embodiments thereof, it is to be understood that modifications or variations may be easily made without departing from the spirit of this invention, which is defined by the appended claims.

What is claimed is:

1. A water recycling system for fuel cell in which a condenser is connected to a fuel cell module for recycling moisture generated by the fuel cell module in operation, comprising:
a water trough, receiving condensed water from the condenser and connecting with a first throttle valve;
a first pump, being connected to the first throttle valve and sucking moisture passing through the first throttle valve;
a fuel tank, having fuel inside, being connected to a second throttle valve, and the second throttle valve being connected to the first pump for the fuel being capable of being pumped out via the first pump;
a mixing tank, being connected to the first pump for receiving mixing liquid of water and the fuel from the first pump; and
a second pump, being connected to the mixing tank for pumping the mixing liquid to the fuel cell module and supplying the fuel with proper thickness to the fuel cell module;
wherein, a thickness sensor and a level sensor are arranged in the mixing tank to detect thickness of the fuel and liquid level of the mixing liquid in the mixing tank; the first throttle valve, the first pump, the second throttle valve, the second pump, the thickness sensor and the level sensor are electrically connected to a micro control unit (MCU) and the MCU is capable of receiving and reading out data of fuel thickness detected by the thickness sensor and data of liquid level detected by the level sensor so as to control actuation of the first throttle valve, the first pump, the second throttle valve and the second pump for regulating and control the thickness of the fuel in the fuel tank.

2. The water recycling system for fuel cell as defined in claim 1 further comprises a moisture collecting tank, which is disposed between the condenser and the water trough.
